(19) United States
(12) Patent Application Publication
(10) Pub. No.: US 2010/0301120 A1
(43) Pub. Date: Dec. 2, 2010

(54) Method for denoting optical recognition data with multicolor light emitters, method for marking the same, light-emitting device, and method for detecting data and position

(75) Inventor: Akiteru Kimura, Chiyoda-ku (JP)

Correspondence Address: OLIFF & BERRIDGE, PLC, P.O. BOX 320850, ALEXANDRIA, VA, 22320-4850, US

(73) Assignee: B-CORE INC., Tokyo (JP)

(21) Appl. No.: 12/801,775

(22) Filed: Jun. 24, 2010

Related U.S. Application Data
(63) Continuation-in-part of application No. PCT/JP2009/051423, filed on Jan. 29, 2009.

(30) Foreign Application Priority Data
Feb. 4, 2008 (JP) 2008-023651

(51) Int. Cl. G06K 7/12; H05B 37/00

(52) U.S. Cl. 235/469; 315/312

(57) ABSTRACT

A technology to measure the position of a distant mark object and denote an automatic recognition data by the object. A light-emitting device includes an R (red) light, a G (green) light, and a B (blue) light emitters, and a control device for controlling their light-up states. The light-emitting device is affixed to the mark object and made to emit the lights by a predetermined light-emitting pattern. The light-emitting pattern forms a time-change optical recognition code denoting a desired data by change of the colors along the time axis. This optical recognition code is accomplished with a small area of space. Further, by photographing the light-emitting device with a CCD camera and the like, it is possible to recognize the position of the light-emitting device, that is, the position of the mark object. By carrying out this behavior continuously, it is possible to trace the movement of the mark object.

### TECHNICAL FIELD

The present invention relates to a method for establishing a predetermined light-emitting format (light-emitting pattern) proceeding along the time axis (the course of time), and making a predetermined light emitter emit a light according to the light-emitting format from a transmitter (emitting side) to a receiver (capturing side), thereby transmitting a data defined by the light-emitting format.

Further, the present invention relates to the technical fields of optical automatic recognition and optical communication which realize the denotation of a particular ID and the like of an object by making a light emitter fixed or affixed to the object emit a light based on a predetermined light-emitting format.

### BACKGROUND ART

There are a number of ways of affixing a predetermined data such as an ID and the like to an article (referred to as a mark or print object). Classically, optical automatic recognition codes such as barcodes and the like are widely utilized. In recent years, however, RFIDs and the like utilizing electromagnetic waves are also utilized. An optical recognition code is such that a predetermined mark is optically read out so as to acquire the original data; thereby the data can be read out if the code exists within a visually observable or recognizable range. On the other hand, an RFID is such that the original data is read out from the RFID by means of electromagnetic wave, thereby having a characteristic that read-out is still possible even if the RFID is visually covered over.

Now, in Point Of Sale (POS) systems utilized in shops and the like, for example, optical automatic recognition codes are commonly utilized for the articles. As optical recognition codes, aforementioned barcodes or color barcodes are utilized. A barcode is a bicolor code originally composed of black and white bars. However, proposals have also been made for the various optical recognition codes utilizing more kinds of colors including chromatic colors (red, blue, yellow, and the like).

The present inventors have also proposed a color barcode referred to as “1D color bit code” in the patent applications (Japanese Patent Application No. 2006-196705 and the like).

Terminology

Herein, an optical recognition code including chromatic color is, for convenience sake, referred to as “color barcode”. Further, when simply a “barcode” is mentioned, it should be regarded as referring to a classical barcode of black and white bars.

Generally, the optical recognition code is often affixed to an object per se or to its container, package, and the like. This affixing behavior is called “marking”.

A “medium” refers generally to the substance or means for embodying a mark through marking. For instance, the “ink” utilized in marking the optical recognition code on an object is a preferred example of the medium. Further, when the object is an article of clothing and the like, a “tag” of heavy paper or the like is often utilized on which the optical recognition code such as a barcode and the like is displayed. In such a case, the “tag” is a preferred example of the medium. Further, the object may also be referred to in particular as “print (mark) object”. This is because conventionally the barcode was often marked particularly through printing (marking), and thus the object was usually regarded as “an object with printed (marked) barcode” (=print object or mark object).

Examples Other than Optical Codes

The optical recognition code denotes a data by means of “optics”. However, there are also known methods for denoting a data with other physical means.

For example, automatic recognition means utilizing electric waves and the like have also been developed and put into practical use such as the RFID. As an example of applying the RFID, there are known noncontact IC rail pass cards and the like.

Communication Examples

Further, as techniques related to “displaying” data, there is a technical field of data “communication”. From the point of view of the data communication technology, there are known a number of examples of applying yet other physical means.

For example, as a means applying optics in the same manner as the optical recognition code, there are known optical communications utilizing optical fibers. Further, even though simply “optics” is mentioned, there are known communication methods with various lights such as infrared light, laser light, visible light, and the like as the intermedia.

Recognition of Position

Meanwhile, it has been conventionally known that the optical recognition code is utilized not only in “denoting” the data but also in recognizing the position of an object.

For instance, as described in the following related art documents (Patent Documents 1 and 2), there are given examples of a position measurement data communication system utilizing infrared as the intermedium.

Related Art Documents

The following Patent Document 1 discloses a position measurement data communication system including a light-emitting member for indicating position and a light-emitting member for transmitting data. The system photographs the light-emitting states of the members with a photography means, measures the position from the photographed image, and carries out data communications according to the blink of the light-emitting members.

Further, the following Patent Document 2 discloses a position detection system including a marker and an individual recognition code output means. The system transmits an individual recognition code by means of infrared, electromagnetic wave and the like, and changes the marker brightness/hue by a predetermined pattern at the same time of transmitting the individual recognition code so as to determine the position of the individual at the same time of receiving the individual recognition code.

[Patent Document 1] Japanese Unexamined Patent Application Publication No. 2001-208511

[Patent Document 2] Japanese Unexamined Patent Application Publication No. 2004-226227

### DISCLOSURE OF THE INVENTION

### Problems to be Solved by the Invention

In order to realize the recognition of position

(1) First, with the automatic recognition means utilizing optical techniques such as barcodes and color barcodes, it is possible to recognize the position of an object by recognizing the position of the code symbol.

However, in order to mark the code, it is necessary to secure a certain area of space on the surface of an object. Further, when blurring has occurred in the image of a captured code symbol, or when the mark surface has changed in direction and the like, it is also presumable that the code cannot be read out.

(2) Further, when the RFID is applied which utilizes electric wave, the degree of freedom of the object position is higher in comparison with the case of utilizing optical techniques. Because of that, however, it is often technically difficult to correctly specify the object position. In practical use, a number of code readers are therefore provided so as to estimate the object position from the position of the code reader which is known to have read out the code. Hence, only a roughly described position can usually be specified such as “on that shelf” and the like. Thus, the precision is not so high either.

(3) Further, as the communication means utilizing lights such as infrared light, laser light and the like, they are primarily laid on the basis of data transmission and reception; thereby, it is generally difficult to correctly recognize the position of a light-emitting object (transmitter).

However, in the cases of a distant object, a violently moving object and the like, in order to specify the position, the necessity to trace the object finally occurs from time to time. Further, when such a tracing is needed, it is generally necessary to recognize the tracing object as “the correct tracing object”.

For example, in the case of tracing an airplane, it is necessary not only to know with some means that the airplane is the tracing object Flight ABC0123 but also to trace the position of the known airplane.

(4) As described above, the information required for tracing some object can be, in a precise sense, listed as follows:

(a) the information indicating “what” the object is; and

(b) the position information indicating the “position” of the object.

These two kinds of information are needed very often.

In order to acquire these two kinds of information, a classical means which has been comparatively often applied is, for example, to get the information of the airplane by means of the communications utilizing electric waves and the like, and then confirm the position of the airplane by means of radar, television camera, and the like. If the distance between the airplanes is wide enough, it may still be possible even by this means to trace an airplane with a sufficient precision.

Further, when the RFID and the like are utilized, the object position can only be known in a rough manner. However, when the objects are few in type or number, it is conceivable to have a comparatively low rate of position misspecification.

Therefore, if the number of the target objects is small and the intervals therebetween are sufficient in distance, it is still possible to trace them with the conventional methods.

However, when the objects are remarkably far away or moving violently, difficult cases have come up from time to time in tracing the objects with the conventional techniques.

(5) Further, in the logistics business, for example, along with the increase of logistic speed, it has no longer been uncommon to see a great number of remarkably different kinds of articles flow along on a conveyer. In such a case, it is difficult to read out the conventional classical barcodes. Therefore, the RFID is, as described hereinbefore, coming into use.

However, since which object is read out can only be roughly known with the RFID, it tends to become unobvious that the information of which object is read out when the moving speed of the objects is extremely high. In the result, it is also presumable that the moving speed of the objects cannot be raised to so high a level. In order to solve this problem, it was necessary to make efforts such as to only flow or convey the objects of as same a kind as possible, etc. At any rate, the problem always tended to be the bottle neck of a system utilizing the RFID.

Accordingly, in the logistics business, there is also widely required a technology capable of tracing an object, specifying its position, and perceiving its contents.

(6) Further, when an object is traced by means of optical technique but not electric wave, it is necessary first to photograph the object and acquire a capture image, and then to carry out a complicated process for the capture image. However, there was often the case that only a limited precision was expectable from the process result for the position information of the object and for the information of specifying the object.

(7) Therefore, although there has been widely longed for a new technology capable of recognizing the position of an object and specifying the object, a promising method therefor has not been discovered yet.

(8) In view of the problems described hereinabove, an object of the present invention is to provide a method for denoting an automatic recognition data which is able to optically identify an object, easily specify its position and easily trace its movement, a device for displaying the automatic recognition data, and other associated techniques therewith.

(9) Further, another object of the present invention is to establish a technology which does not require a large area of space on a mark object for marking the optical recognition code.

Especially, if a large area of space is required, there occurs a necessity to take a large photograph of the medium displaying the optical recognition code while being photographed. Thereby, in the cases of there being a plurality of mark objects, tracing a moving object, and the like, the degree of freedom may be concernedly lowered.

Accordingly, it is preferable that the optical recognition code can be marked with a smaller medium which does not occupy a large area of space on the image when photographed.

As will be described hereinafter, in order to achieve this object, the present invention proposes a new optical recognition code in which the colors change along the time axis. The particulars will be described in detail thereinafter in the embodiment and the like.

### Means for Solving the Problems

In particular, the present invention adopts such means as follows.

(1) In order to solve the above problems, the present invention provides a light-emitting device comprising: a light emitter 1 emitting a color light 1; a light emitter 2 emitting a color light 2; a light emitter 3 emitting a color light 3; and a control means for lighting up and blacking out each of the light emitters 1 to 3 in a predetermined light-emitting pattern, the light-emitting device denoting a predetermined data by the predetermined light-emitting pattern.

(2) Further, in order to solve the above problems, the present invention provides a light-emitting device comprising: n kinds of light emitters 1 to n emitting color lights 1 to n, respectively; and a control means for lighting up and blacking out each of the n kinds of light emitters 1 to n in a predetermined light-emitting pattern, the light-emitting device denoting a predetermined data by the predetermined light-emitting pattern; and the n being an integer more than 1.

(3) Further, in order to solve the above problems, the light-emitting device of the present invention according to the description (1) or (2), wherein the light-emitting pattern denotes the data by a sequence of change, transition, or light-up and black-out of the colors.

(4) Further, in order to solve the above problems, the light-emitting device of the present invention according to the description (1) or (2), wherein the light-emitting pattern denotes the data by the colors.

(5) Further, in order to solve the above problems, the light-emitting device of the present invention according to the description (1) or (2), wherein in the light-emitting pattern, at most only one of the colors switches between a light-up state and a black-out state at a time.

(6) Further, in order to solve the above problems, the light-emitting device of the present invention according to the description (1) or (2), wherein in the light-emitting pattern, at least any one or more of the light emitters is/are constantly in a light-up state; and in no circumstances will all the light emitters be in a black-out state at the same time.

(7) Further, in order to solve the above problems, the light-emitting device of the present invention according to the description (1) or (2), wherein the light-emitting pattern comprises a unit pattern for denoting the predetermined data; and a margin pattern for indicating a boundary of the unit pattern.

(8) Further, in order to solve the above problems, the light-emitting device of the present invention according to the description (7), wherein in the margin pattern, at least any one or more of the light emitters is/are constantly in a light-up state; and in no circumstances will all the light emitters be in a black-out state at the same time.

(9) Further, in order to solve the above problems, the light-emitting device of the present invention according to the description (8), wherein in the margin pattern, any of the light emitters is constantly in a light-up state.

(10) Further, in order to solve the above problems, the light-emitting device of the present invention according to the description (9), wherein in the margin pattern, any of the light emitters other than those constantly in a light-up state repeatedly switches between light-up and black-out on a predetermined timing.

(11) Further, in order to solve the above problems, the light-emitting device of the present invention according to the description (7), wherein the unit pattern comprises a start pattern for indicating a start of the unit pattern, and an end pattern for indicating an end of the unit pattern; the unit pattern starts from the start pattern and ends with the end pattern.

(12) Further, in order to solve the above problems, the light-emitting device of the present invention according to the description (1) or (2), wherein in the light-emitting pattern, a timing of light-up or black-out of the light emitters is predetermined.

(13) Further, in order to solve the above problems, the light-emitting device of the present invention according to the description (12), wherein an interval of the timing of light-up or black-out of the light emitters changes from a short period to a long period in a sequentially repeated manner.

(14) Further, in order to solve the above problems, the light-emitting device of the present invention according to the description (1), wherein the light emitter k is formed of a small light emitter or emitters emitting the color light k; the k is an integer from 1 to 3.

(15) Further, in order to solve the above problems, the light-emitting device of the present invention according to the description (2), wherein the light emitter k is formed of a small light emitter or emitters emitting the color light k; the k is an integer from 1 to n.

(16) Further, in order to solve the above problems, the light-emitting device of the present invention according to the description (14) or (15), wherein the small light emitter or emitters emitting the color light k is/are fixed or quasi-fixed in position each other.

Herein, “quasi-fixed” refers to such a state as linked within a range of a certain degree of freedom, and the like such as linked with a rope and the like, as will be described hereinafter in the embodiment, for distinguishing from the state of being completely “fixed” to be unmovable.

(17) Further, in order to solve the above problems, the light-emitting device of the present invention according to the description (1) or (2), wherein the light emitters are fixed or quasi-fixed in position each other.

(18) In order to solve the above problems, the present invention provides a method for marking a mark object with an optical recognition code which utilizes the light-emitting device according to any one of the descriptions (1) to (17) and in which the colors change along the time axis, the method comprising: a disposition step of disposing the light-emitting device on the mark object; and a light emitting step of making the light-emitting device emit the lights in the predetermined light-emitting pattern; the lights emitted by the light emitters forming the optical recognition code denoting the predetermined data.

(19) Further, in order to solve the above problems, the method for marking a mark object with an optical recognition code of the present invention according to the description (18), wherein the light-emitting device comprises a storage means for storing the light-emitting pattern inputted from outside; and the control means changes a light-emitting state of the light emitters in accordance with the light-emitting pattern stored in the storage means so as to denote the optical recognition code.

(20) In order to solve the above problems, the present invention provides a method for denoting an optical recognition code which utilizes the light-emitting device according to any one of the descriptions (1) to (17) and in which the colors change along the time axis, wherein the light-emitting device comprises a storage means for storing the light-emitting pattern inputted from outside; and the control means changes a light-emitting state of the light emitters in accordance with the light-emitting pattern stored in the storage means so as to denote the optical recognition code.

(21) In order to solve the above problems, the present invention provides a data and position detection method for recognizing a position of a mark object by affixing to the mark object the light-emitting device according to any one of the descriptions (1) to (17) and utilizing an optical recognition code denoted by the light-emitting device, the method comprising the steps of: photographing an image including the light-emitting device denoting the optical recognition code for denotation; recognizing the optical recognition code from the photographed image so as to seek the position; and reading out the recognized optical recognition code so as to restore the data denoted by the optical recognition code, so as to acquire the position of the mark object marked with the optical recognition code and the data denoted by the optical recognition code.

### Effects of the Invention

As has been described hereinabove, according to the present invention, it is possible to specify the position of a distant object and recognize the automatic recognition data associated with the mark object.

### BRIEF DESCRIPTION OF THE DRAWINGS

FIG. 1 is a diagram showing a time chart of a light-emitting pattern;

FIGS. 2A, 2B, and 2C are diagrams showing capture images;

FIGS. 3A, 3B, and 3C are diagrams showing other capture images;

FIG. 4A and FIG. 4B are diagrams showing a helmet to which a light-emitting device is affixed, respectively;

FIG. 5 a diagram showing a jacket to which a light-emitting device is affixed;

FIG. 6 is a diagram showing a road traffic sign to which two light-emitting devices are affixed;

FIG. 7A and FIG. 7B are diagrams showing a Christmas tree to which a light-emitting device is affixed; and

FIG. 8 is a diagram showing a time chart of another light-emitting pattern.

### REFERENCE NUMERALS

10 Light-emitting pattern

13r Light-emitting pattern of a red light emitter

13g Light-emitting pattern of a green light emitter

13b Light-emitting pattern of a blue light emitter

20, 22, and 24 Capture image

30, 32, and 34 Capture image

40, 42, 44, 46, and 48 Light-emitting unit

40r, 42r, and 44r Red light emitter

40g, 42g, and 44g Green light emitter

40b, 42b, and 44b Blue light emitter

50 Helmet

52 and 54 Light-emitting device

52r and 54r Red light emitter

52g and 54g Green light emitter

52b and 54b Blue light emitter

60 Jacket

70 Light-emitting device

70r Red light emitter

70g Green light emitter

70b Blue light emitter

80 Road traffic sigh

90 Light-emitting device

90r Red light emitter

90g Green light emitter

90b Blue light emitter

100 Christmas tree

100r Red light emitter

100g Green light emitter

100b Blue light emitter

120 Decoration piece

t0, t1, t2, t40, and t41 Time

T1, T2, T3, and T4 Time

### BEST MODE FOR CARRYING OUT THE INVENTION

Hereinbelow, explanations will be given for an embodiment configured for solving the above-described problems in reference to the accompanying drawings.

No. 1 Outline and Principle

In the embodiment, explanations will be given for an example of affixing light emitters to an object, and denoting an automatic recognition data with respect to the object by a light-emitting pattern of the lights emitted by the light emitters while specifying the position of the object as well.

(1) First, three kinds of light emitters are disposed on an object. The three kinds of light emitters make the lights of three different colors blink in a predetermined pattern. This behavior is also referred to as a light emitter disposition step.

In the embodiment, the three kinds of light emitters are: red color light emitting LED (referred to as R hereinbelow), green color light emitting LED (referred to as G hereinbelow), and blue color light emitting LED (referred to as B hereinbelow).

These three kinds of LEDs are small light-emitting means and easily available. In the embodiment, an automatic recognition data is expressed with the three-color lights (red color light, green color light, and blue color light) emitted by these LEDs (light emitters).

Further, the three kinds of LEDs are provided with a control device formed with integrated circuits, programs and the like to control the LEDs so as to denote a predetermined light-emitting pattern. In the embodiment, one control device carries out all the controls of the three kinds of LEDs. However, it is also preferred to configure such that each of the LEDs is provided with a control device respectively, and the LEDs are synchronized each other with a suitable means (to accord the timing of blinks).

In the embodiment, the above-described three kinds of LEDs (light emitters), the control device, and a power supply of a predetermined small battery and the like compose a light-emitting device (also referred to as a light-emitting unit) for denoting a predetermined light-emitting pattern.

(2) Next, the three kinds of light emitters are made to blink based on a predetermined light-emitting blink pattern. This behavior is also referred to as a light-emitting step.

An automatic recognition data with respect to the object is denoted through these processes (the light emitter disposition step and the light-emitting step).

Storage of Light-Emitting Pattern

Besides, the control device is supposed to be provided with a storage means for storing the light-emitting pattern. It is preferable that the light-emitting pattern be prestored in the storage means; it is also preferable to configure such that a predetermined light-emitting pattern can be written thereinto from outside.

Light-Emitting Pattern

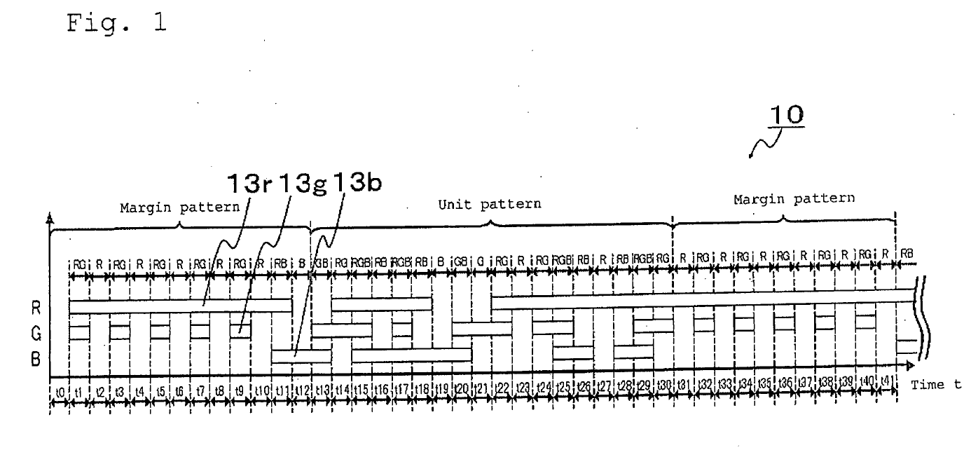

In the embodiment, the three kinds of LEDs (light emitters) blink based on a light-emitting pattern 10 defined by time and color. FIG. 1 shows an explanatory diagram of the light-emitting pattern 10.

About Flashing

Further, in the embodiment, flashing refers to the behavior of one light emitter being lighted up and blacked out. Further, blinking refers to the behavior along with a change in brightness including down to an intermediate brightness in addition to flashing. That is, blinking is a concept including flashing.

In the embodiment, in order to make the explanations easy to understand, most examples will be shown with flashing. However, it is also preferred to be with a light-emitting pattern which also includes a kind of intermediate brightness. In order to include such a case, the term “blinking” is utilized.

Now, as shown in FIG. 1, the light-emitting pattern 10 is illustrated by a two-dimensional time chart, wherein the vertical axis represents the three kinds of colors (red, green, and blue) while the horizontal axis represents (the course of) time.

The vertical axis is divided into three segments showing each of the colors respectively (see FIG. 1). The top segment shows a red light-emitting pattern 13r. As shown in FIG. 1, the red light-emitting pattern 13r is blacked out during the period t0 while lighted up during the periods t1 to tn. Further, in this manner, in the embodiment, t0, t1, and the like represent predetermined periods.

Therefore, R is lighted up from the period t1 to the period tn. Hereafter, according to the light-emitting pattern shown in FIG. 1, R repeatedly switches between being lighted up and being blacked out during the time periods t12 to t41.

Further, on the middle segment of the vertical axis of the light-emitting pattern 10 of FIG. 1, a green light-emitting pattern 13g of G is shown; and on the bottom segment, a blue light-emitting pattern 13b of B is shown.

Blinking and Flashing

In the embodiment, the term “flashing” is utilized to indicate “light up” and “black out”, that is, to indicate 0% brightness and 100% brightness. In addition to this, the term “blinking” is utilized to indicate a change in brightness including down to an intermediate brightness (50% and the like). That is, blinking is utilized as a term including flashing in meaning.

Time-Change Optical Recognition Code

The embodiment is characterized by the fact that the light-emitting pattern forms an optical recognition code. It is particularly characteristic that the optical recognition code of the embodiment is such that the colors change along the time axis. This is, herein, called a time-change optical recognition code.

Conventional optical recognition codes dispose various colors in a so-called “spatial” manner. In a practical sense, the term “spatial” utilized herein refers often to-one-dimensional or tow-dimensional cases, and thus a conventional optical recognition code is such that the predetermined colors have been arranged (in a one-dimensional or two-dimensional manner) on a (two-dimensional) plane surface. That is, the colors change along according to the spatial position, and the data is expressed by the colors changing along.

On the other hand, in the aforementioned time-change optical recognition code of the embodiment, the colors change along in a predetermined pattern according to the course of time, and the data is expressed by this change pattern.

In such a time-change optical recognition code, the colors do not change spatially but change temporally. Thereby, it is characteristic that the optical recognition code only needs to occupy a small area of space on the article.

On the other hand, since it is necessary for a conventional optical recognition code to “arrange” the colors spatially, a certain area of space is required for affixing (marking) the code on the object. Yet, because the colors change along with time in the time-change optical recognition code of the embodiment, only a small appropriative area is generally required on the object.

The light-emitting pattern 10 shown in FIG. 1 is of a code formed according to the rules of the “1.5D color arrangement code” described in Japanese Patent Application No. 2006-196705, another application for a patent made by the present inventors.

The “1.5D color arrangement code” used to be arranged on a two-dimensional plane surface. It has been changed here in the embodiment into a code on the time axis, forming the pattern shown in FIG. 1. That is, the “1.5D color arrangement code” will be restored by expressing the pattern shown in FIG. 1 as it is on a plane surface.

In this manner, in the embodiment, the light-emitting pattern is expressed on a two-dimensional time chart with the axes of the course of time and the kind of color so as to express a predetermined data based on the rules of the “1.5D color arrangement code”.

In addition, the particulars of the rules are as follows.

(a) The colors do not change in the middle of each period but change at a boundary between the periods.

(b) Of R, G, and B, at most only one color is allowed to change at the above-described boundary (that is, in no circumstances will two or three colors change at the same time).

(c) In the middle of denoting the light-emitting pattern, in no circumstances will R, G, and B all disappear at the same time.

Further, as shown in FIG. 1, in the embodiment, the light-emitting pattern 10 is composed of a “unit pattern” and a “margin pattern”.

First, the “unit pattern” refers to the portion denoting a single automatic recognition data. It is defined by the number of the aforementioned periods, and corresponds to the module in accordance with the description of Japanese Patent Application No. 2006-196705. In other words, the number of the periods agrees in meaning and effect to the times of change in light-up state of the colors.

If the unit pattern were displayed continuously, the separation from each other would tend to become unclear. Therefore, a margin is inserted therebetween. That is the “margin pattern” which is provided between the “unit patterns”.

Generally, it is insufficient for the unit pattern to “emit the lights” only once to denote the data. Therefore, the unit pattern is usually displayed a number of times in a repeated manner. Hence, in order to make the separation clear for each of the unit patterns, the margin pattern is inserted.

Therefore, in the embodiment, the “margin pattern” is provided in a certain form between the “unit patterns” as the separation for each of the “unit patterns”.

Further, the margin pattern is inserted not only for the case of applying the identical unit pattern but also for the case of interweaving multiple kinds of “unit patterns” consecutively in display.

In the embodiment, it is determined that the light-emitting pattern of the “margin pattern” may be such that the rule “any of R, G, and B must emit the light” is observed. Besides, in the embodiment, the “margin pattern” is also referred to as a “margin portion”.

As long as the above rule is observed, it is possible to utilize any kinds of patterns as the margin pattern.

This is because if the light-emitting pattern of the “margin pattern” includes the case that all the light emitters are blacked out during a predetermined period, it will become difficult to recognize whether or not that light-emitting pattern is of the same (object) before and after they are blacked out. In order to avoid this situation, it is effective to keep at least one of the R, G, and B being lighted up in the “margin pattern” as described hereinabove.

Hence, the light-emitting pattern 10 of the embodiment has adopted a margin pattern in which R is constantly lighted up while G keeps blinking. This is shown in the light-emitting pattern 10 of FIG. 1.

On the other hand, in the light-emitting pattern of the “unit pattern”, in order to avoid the same problem described hereinabove, at least one of the light emitters is constantly lighted up as well (the aforementioned rule c). As a result, in the embodiment, the light-emitting pattern has been formed such that at least one of the light emitters is constantly lighted up; and it is based on the rules of the 1.5D color arrangement code described hereinbefore.

Further, in the “1.5D color arrangement code”, there are no specific rules on the length of each “period”. In the embodiment, it is also possible to set freely a light-emitting time (period) for R, G, and B. The automatic recognition data to be expressed is denoted only on the basis of the sequence, change, and/or transition of blink of the light emitters, but without any direct relations to the (length of) light-emitting period of each color. As a result, in the embodiment, it is possible to restore the original data by detecting the change of color only.

In this manner, because the system is adopted which basically does not set up a particular rule on the length of “period”, the aforementioned margin pattern also does not adopt “something only keeping a light-up state during a predetermined period” but a “pattern” keeping blinking repeatedly during the predetermined period.

As described hereinabove, in the embodiment, the “unit pattern” is determined by the light-emitting pattern based on the rules of the 1.5D color arrangement code, and the “margin pattern” also adopts the “pattern” which keeps blinking repeatedly during the predetermined period as described hereinabove.

Further, when the aforementioned lighting-emitting pattern is applied to the “margin pattern”, it is preferred to form such a light-emitting pattern as not including the same light-emitting pattern as the margin pattern for the “unit pattern”.

Further, in the embodiment, it is preferable that the recognition means for recognizing the time-change optical recognition code be configured by an automatic recognition data readout apparatus composed at least of a capture camera and a computer system for carrying out image processing and the like.

Unit Pattern

Further, the unit pattern includes a predetermined start pattern and a likewise predetermined end pattern. The start pattern indicates the start of the unit pattern while the end pattern indicates the end of the unit pattern. By virtue of the start pattern and end pattern, the readout means and the like become able to know the start and the end of the unit pattern.

No. 2 Disposition of Light Emitters R, G, and B

In the embodiment, if the lights of the light emitters R, G, and B can be displayed to the recognition means, the actual user is able to freely determine the disposition (layout) of the light emitters R, G, and B.

Generally, it is preferable to carry out marking by disposing R, G, and B close to each other and affixing the same collectively to the predetermined place of an object. That is, the marking is carried out by such a method as affixing a small light-emitting device (light-emitting unit) provided with the R, G, and B to an object through adhering, binding with cords and the like, fastening with tapes and the like, etc.

However, various other disposition methods are also conceivable than disposing R, G, and B close to each other in one place. Explanations therefor will be given hereinbelow.

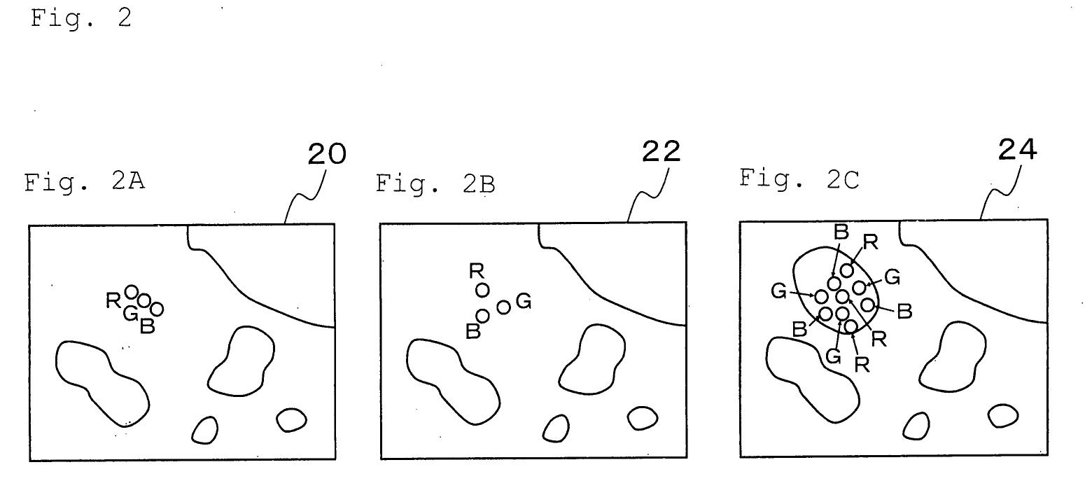

FIGS. 2A, 2B, and 2C show three kinds of capture image examples in which the objects including R, G, and B have been captured by a capture means which is the recognition means (CCD camera and the like).

For instance, as shown in the capture image 20 of FIG. 2A, it is also a preferable example to dispose R, G, and B in a row.

Further, as shown in the capture image 22 of FIG. 2B, it is also a preferable example to dispose R, G, and B in such a manner as drawing a triangle.

Further, as shown in the capture image 24 of FIG. 2C, it is also a preferable example to dispose a group of R's, a group of G's, and a group of B's blending together.

Further, in FIG. 2C, each R (red color LED) included in the group of R's blinks in a synchronized manner. Likewise, each G (green color LED) included in the group of G's also blinks in a synchronized manner. Still likewise, each B (blue color LED) included in the group of B's also blinks in a synchronized manner. The predetermined control means described hereinbefore performs the synchronization for each group.

In this manner, when multiple light emitters form a single color, the light emitter is particularly referred to as a small light emitter.

In addition, in any of FIGS. 2A, 2B, and 2C, it is generally a preferable layout to dispose the R, G, and B close to each other. This is because it thus becomes easy to capture the R, G, and B at a time, and often able to reduce the appropriative area on an object as well. If R, G, and B can be captured at one time, it will become easy to carry out the following processes and thereby easy to recognize the light-emitting pattern in image processing.

Further, especially with the layout of FIG. 2C, even if some of the light emitters of R, G, and B are blocked by obstruction and thus unable to reveal the lights to the recognition means, the possibility increases that other light emitters of the same colors as the blocked R, G, and B are able to reveal the lights to the recognition means. Therefore, by virtue of such a layout as shown in FIG. 2C, there is an acquirable effect that the influence from obstruction becomes more restrained in comparison with the layouts of FIGS. 2A and 2B.

Positional Relation (Fixed or Quasi-Fixed)

In this manner, it is preferable to “fix” the light emitters of R, G, and B close to each other. However, when they are linked with ropes and the like, it is possible to bring a certain flexibility into the positional relation. Such a case as a flexibility is brought into the positional relation is particularly referred to as “quasi-fixed” to distinguish from the fixed cases.

This is also applicable to the case of forming a single color, with multiple small light emitters such as in FIG. 2C: it is preferable to “fix” the multiple small light emitters, and it is also preferable to “quasi-fix” them by such a configuration as providing them on a cloth so as to bring a certain flexibility thereinto.

No. 3 Tracing

In the embodiment, when the light emitters (R, G, and B) are moving within a range recognizable by the recognition means, it is preferred that the recognition means specify their positions while tracing the light emitters (R, G, and B), and recognize the light-emitting pattern denoted by the light emitters (R, G, and B).

In addition, although the light emitter R, the light emitter G, and the light emitter B have been called respectively so far, they are actually included in a single light-emitting device (also referred to as a light-emitting unit) which is provided with the three-color LEDs, a control device, and a power supply, as has already been described. The control device has stored a predetermined light-up pattern provided from outside, and lights up and blacks out each of the light emitter LEDs (R, G, and B) according to the light-up pattern.

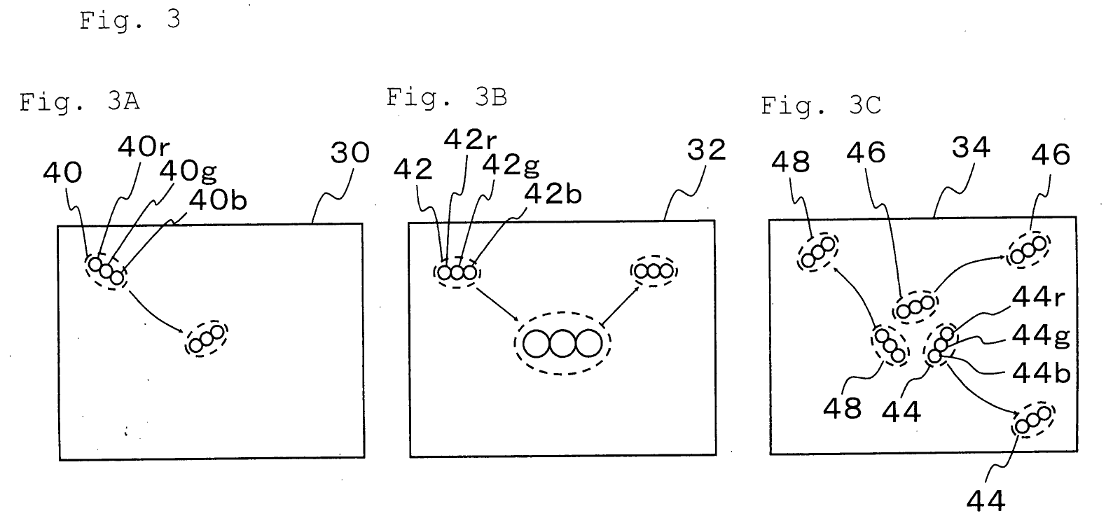

FIGS. 3A, 3B, and 3C show three capture images 30, 32, and 34 in which the recognition means has captured the moving light emitters (R, G, and B).

Simple Movement

First, explanations will be given with respect to the capture image 30 of FIG. 3A which shows an image of a light-emitting unit 40 moving from an upper left portion to the central portion of the capture image 30 along the arrow mark.

The light-emitting unit 40 includes R40r, G40g, and B40b disposed close to each other and, as has been described so far, a control device, and a power supply.

The R40r, G40g, and B40b emit the lights according to the light-emitting pattern which has been described so far so as to denote a predetermined code while moving.

According to the light-emitting pattern, as described hereinbefore, any of the light emitters (R, G, and B) is constantly lighted up. Therefore, the recognition means is able to trace the light emitted by the light-emitting unit 40 so as to specify the position of the light-emitting unit 40. Further, by recognizing the light-emitting pattern denoted by the light-emitting unit 40, it is possible to recognize the code denoted by the light-emitting unit 40 so as to read out the data denoted by the code.

Movement Along with Distance Change

Next, the capture image 32 of FIG. 3B shows an image of a photographed light-emitting unit 42 which is a set of light emitters R42r, G42g, and B42b disposed close to each other. In the capture image 32, the light-emitting unit 42 moves close to the recognition means from afar, and then moves away from the recognition means again.

In particular, in the capture image 32, at first the small light-emitting unit 42 is shown in an upper left portion of the capture image 32, then gets as larger as coming closer to the central portion of the capture image 32, and further becomes smaller again while moving to an upper right portion of the capture image 32 (see FIG. 3B).

The R42r, G42g, and B42b of the light-emitting unit 42 blink in a predetermined light-emitting pattern, and thus accomplish a 1.5D color arrangement code on the so-called time axis as described hereinbefore. The 1.5D color arrangement code was originally such that the color changes in a spatial (plane) manner so as to denote a predetermined data, and is now transformed such that the color changes on the time axis.

Thence, the recognition means is able to specify or recognize the blinks so as to detect the position of the light-emitting unit 42 and read out the data denoted by the code (at the same time).

Existence of Multiple Light-Emitting Units

Further, the capture image 34 of FIG. 3C shows an image of three kinds of light-emitting units 44, 46, and 48 photographed.

The light-emitting unit 44 is configured by disposing R44r, G44g, and B44b close to each other. The light-emitting units 46 and 48 also adopt the same configuration.

Now, in the capture image 34, at first all the units 44, 46, and 48 gather in the central portion of the capture image 34.

Then, the light-emitting unit 44 moves from the central portion of the capture image 34 to a lower right portion along the arrow mark. Further, the light-emitting unit 46 moves from the central portion of the capture image 34 to an upper right portion along the arrow mark. Further, the light-emitting unit 48 moves from the central portion of the capture image 34 to an upper left portion along the arrow mark. Each of the light-emitting units 44, 46, and 48 moves at the same time while denoting the different light-emitting pattern, respectively, according to the rules of the 1.5D color arrangement code described hereinbefore, that is, denoting the different data (ID and the like of the article), respectively.

In the embodiment, based on a predetermined distance standard, the recognition means recognizes the lights (light emitters) positioned apart such that the distance standard is reached or exceeded as belonging to different light-emitting units respectively, but the light emitters positioned apart such that the distance standard is neither reached nor exceeded as belonging to the same light-emitting unit.

In the aforementioned capture image 34 (FIG. 3C), because each distance between the light-emitting units 44, 46, and 48 is kept longer than the distance standard, the recognition means is able to distinguish and trace each of the light-emitting units 44, 46, and 48, recognize each of the positions and each of the denoted codes, and read out each of the data denoted by the codes.

Further, each distance between R44r, G44g, and B44b belonging to the light-emitting unit 44 is set shorter than the aforementioned distance standard.

No. 4 Disposing Position of Light-Emitting Device (Light-Emitting Unit)

In the embodiment, the light-emitting device (also referred to as light-emitting unit) refers, as has already been described, to a device configured by combining light emitters R, G, and B, a predetermined control device, and a power supply for denoting an automatic recognition data.

As has been described so far, one of the characteristics of the method for denoting an automatic recognition data in accordance with the embodiment is the aspect of recognizing the code denoted by the light-emitting pattern, and the position of the light emitters at the same time.

The light-emitting device of the embodiment regards it as a premise to be marked on an object. As a result, it is possible to regard the position of the light-emitting device acquired by the recognition means as the position of the object on which the light-emitting device has been marked (affixed). By virtue of this, it is possible to recognize the data such as the ID and the like denoted by the light-emitting device, and to specify the position of the object at the same time.

In order to accomplish that, it is regarded tacitly as a premise that the light-emitting device is disposed on the object. In other words, in order to specify the position of an object, it is necessary that the light-emitting device is affixed on the surface of the object in a fixed state or a state similar thereto.

From this point of view, in this section, detailed explanations will be given with respect to the position of disposing the light-emitting device on an object.

Helmet

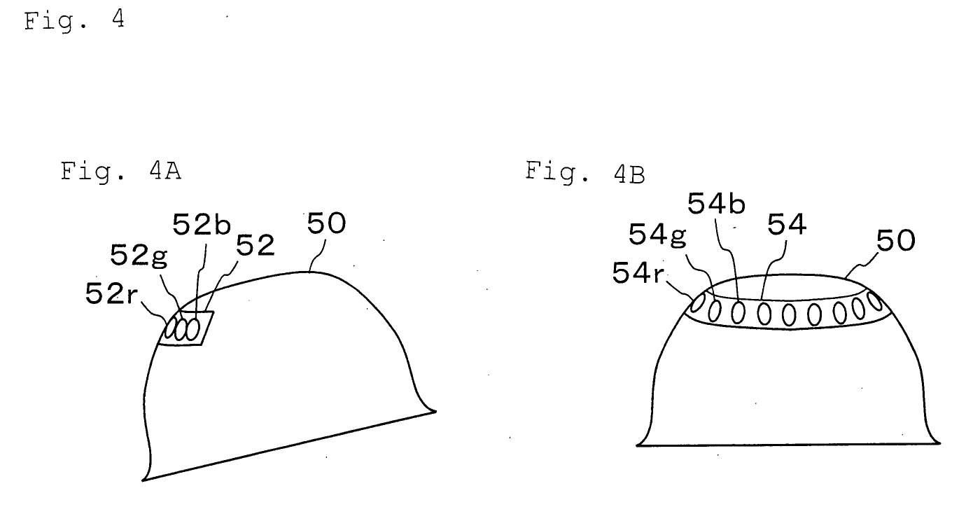

FIGS. 4A and 4B show two kinds of explanatory diagrams showing examples of affixing different light-emitting devices provided with R, G, and B to the outside of a helmet, respectively.

First, FIG. 4A is an explanatory diagram showing an example of affixing a light-emitting device 52 to a helmet 50 in a predetermined direction (for example, on the front side only). The light-emitting device 52 includes R52r, G52g, and B52b, and blinks according to the rules of the 1.5D color arrangement code as described hereinbefore.

Further, FIG. 4B is an explanatory diagram showing an example of affixing a light-emitting device 54 to the helmet 50 around a peripheral portion. The light-emitting device 54 includes multiple R54r, multiple G54g, and multiple B54b so as to display each color respectively with the multiple light emitters. Then, the light-emitting device 54 blinks in a predetermined pattern to denote a predetermined data.

Based on the blinks, the recognition means reads out the positions of the light-emitting devices 52 and 54, and the codes denoted by the light-emitting patterns, respectively.

As shown in FIGS. 4A and 4B, when the light-emitting devices 52 and 54 are affixed to the outside surface of the helmet 50, it is possible to regard the position information held by the recognition means as almost the same as that of the helmet 50.

As a result, the recognition means is able to recognize the position information of the helmet 50 and the code denoted by the light-emitting devices 52 and 54 at the same time by reading out the blink of the light-emitting devices 52 and 54.

Especially in FIG. 4B, since the light-emitting device 54 is affixed around the helmet 50, if the helmet 50 is viewed from above, it is possible to recognize the blink of the light-emitting device 54 from any position and angle.

By virtue of this, in a certain workplace, for example, by setting up a camera as the recognition means on the ceiling of the workplace, etc., it becomes possible to constantly get hold of the position and ID of a worker. As a result, it is possible to make such estimations as “The worker Sato is in the back site.”, “The worker Suzuki has not shown himself for a long time. Some accident may have occurred.”, and the like. Thereby, it is possible to smoothly carry out the management of the workplace so as to improve working efficiency and to accomplish a safe working environment by preventing accidents from occurring at the same time.

Further, FIGS. 4A and 4B show the examples of affixing the light-emitting devices 52 and 54 to the helmet 50 “thereon”. However, when the light-emitting devices 52 and 54 are, for example, formed of a flexible member such as a chin strap, and affixed and utilized as the chin strap of the helmet 50, the same effect are also acquirable as that of affixing the light-emitting devices 52 and 54 to the helmet 50 per se thereon. However, in this case, it is considered a little difficult to recognize the information from the helmet 50; therefore, it will be preferable to set up the recognition means, such as a camera and the like, at the same height as that of the worker.

Clothes

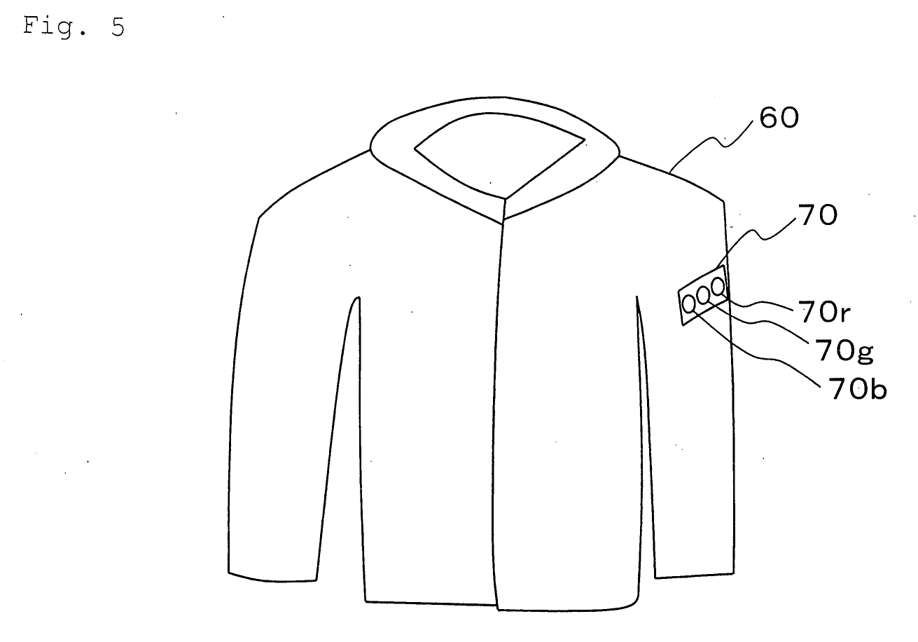

FIG. 5 is an explanatory diagram showing an example of affixing a light-emitting device 70 including R70r, G70g, and B70b to the left sleeve of a jacket 60. In the example shown in FIG. 5, it may often be possible as well to certify the position information of the light-emitting device 70 acquired by the recognition means (no shown) as almost the same as the position information of the jacket 60.

Therefore, by recognizing the blink of the light-emitting device 70, the recognition means is able to get hold of the position information of the jacket 60, and the data (the personal information of the wearer, and the like) denoted by the code denoted by the light-emitting pattern at the same time. If the jacket is a working wear, then it can be utilized for the same purpose as the aforementioned helmet, thereby being able to facilitate the construction of a safer working environment.

In addition, in a selling place where the jacket 60 is sold, it is preferred to utilize the information of the jacket 60 (price, size, material, and the like) as the aforementioned data.

Road Traffic Sign

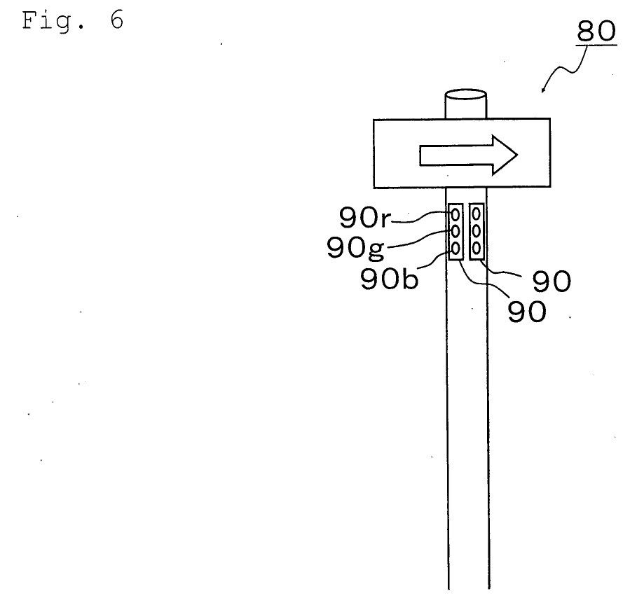

Further, FIG. 6 shows a road traffic sign 80 indicating one-way traffic. On the surface of the pole of the road traffic sign 80, two light-emitting devices 90 are provided which include R90r, G90g, and B90b. Although the road traffic sign 80 is statically fixed on a road and the like, while being viewed from the recognition means provided, for example, in a moving automobile, the road traffic sign 80 is recognized as “a moving object” in the same manner as an actually moving object.

By recognizing the position of the light-emitting devices 90 and the code denoted by the light-emitting devices 90, the recognition means is able to play an audio message inside the automobile such as “This is a one-way road.” and the like to call the driver's attention.

No. 5 Light-Emitting Pattern of Light Emitter

In the embodiment, the data denoted by R, G, and B is, as described hereinbefore, denoted merely on the basis of the blink sequence of R, G, and B (including the sequences of change, transition, light-up/black-out, and the like of the color). Therefore, it is possible in principle for an actual user to freely determine the time interval (period) of the blinks of R, G, and B.

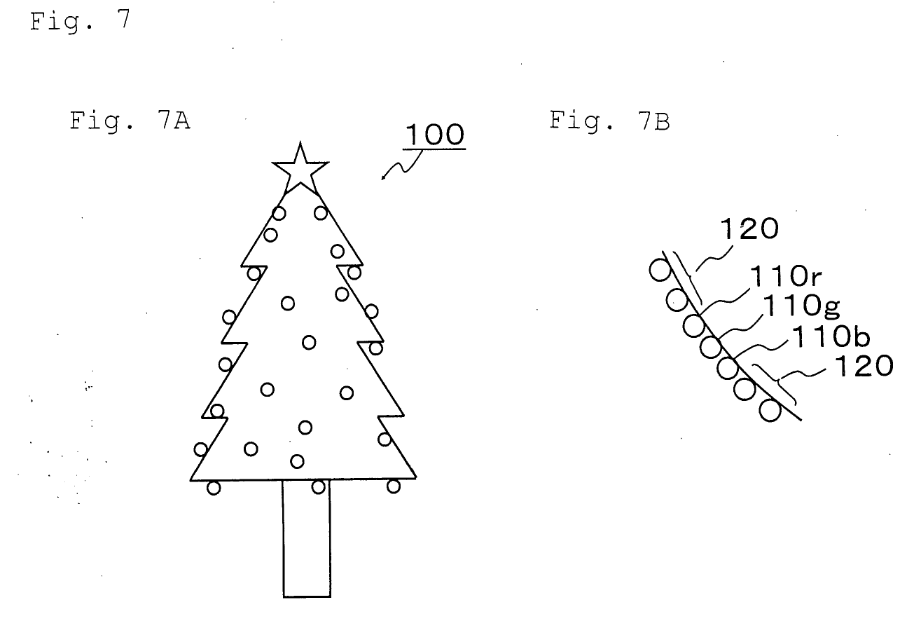

However, such as a Christmas tree 100 shown in FIG. 7A, decorations may be made by a number of decoration pieces to show multicolor blinks. For example, when R, G, and B denoting a data are affixed to the Christmas tree 100 and blink, decoration pieces 120 may often be, as shown in FIG. 7B, mixed therein. The decoration pieces 120 also emit lights, but neither have relation to light emitters R110r, G110g, and B110b provided for denoting the data nor have relation to the data. Especially, because a Christmas tree generally has many light-emitting decoration pieces (light bulbs, LEDs, and the like), it is conceivable that such a case as described hereinabove may occur frequently.

In this manner, there may be various colors having no relation to the data. When these colors are blinking (or look like blinking), they are very likely to get mixed up with the light-emitting pattern of R110r, G110g, and B110b, and with the background (decoration pieces not denoting the data) as well.

Therefore, in the embodiment, R110r, G110g, and B110b are configured to blink during different periods from those during which the decoration pieces 120 blink therearound. With such a configuration, it is possible to distinguish R110r, G110g, and B110b from the decoration pieces 120.

Therefore, although it is possible in principle to freely determine the time interval (period) during which R, G, and B blink, in order to distinguish from decoration pieces of the Christmas tree, the period should be selected and determined from different values from those of blink interval of the decoration pieces. Because the blink interval of the decoration pieces is usually between a few hertz to a few tenths of a hertz, it is preferable to select a period without that range for the blink interval during which the light emitters blink in the light-emitting device.

Accordingly, an example will be shown as below for the light-emitting pattern in the case of having predetermined the period.

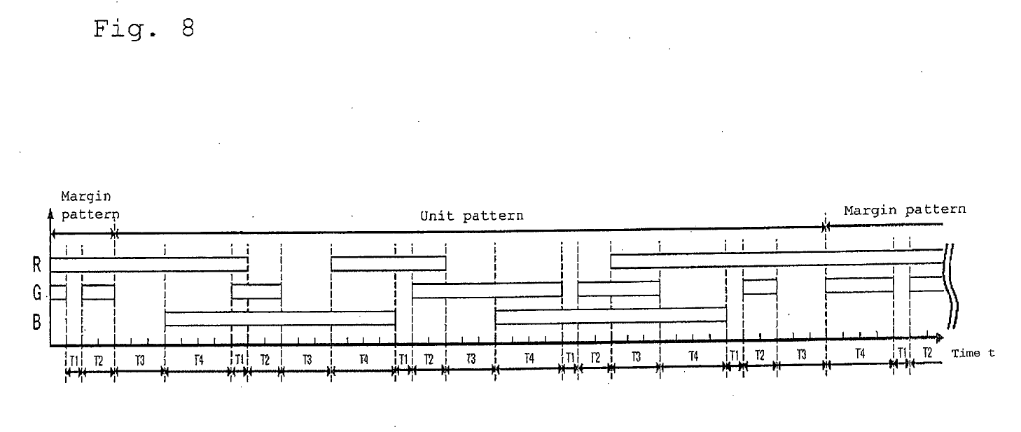

FIG. 8 shows a preferred example of the light-emitting pattern of R110r, G110g, and B110b described hereinabove. The light-emitting pattern shown in FIG. 8 is, in the same manner as in FIG. 1 described hereinbefore, shown by a two-dimensional time chart in which the horizontal axis represents the course of time T while the vertical axis represents the three colors R, G, and B.

As shown in FIG. 8, each period in the light-emitting pattern of R110r, G110g and B110b (the period during which the light-up state changes) changes repeatedly in a cyclical manner in the sequence of periods T1, T2, T3, T4, and T1.

The period T1 is the basic unit period (basic length) of blink time in the light-emitting pattern, and the following periods T2, T3, and T4 are set to integral multiples of the basic unit period.

For example, the period T2 is twice the period T1. Further, the period T3 is three times the period T1, and the period T4 is four times the period T1.

As the time of the period T1, T2, T3, or T4 has passed (at the boundary of each period), any one of the R110r, G110g, and B110b changes in state in such a manner as switching either from black-out to light-up or from light-up to black-out.

On the other hand, because it is conceivable to have a remarkably low possibility that the mere decoration pieces which do not denote the data are lighted up or blacked out during the cyclical periods T1, T2, T3, and T4 described hereinabove, the recognition means is able to pick out the light emitters which are lighted up and blacked out during the cyclical periods T1, T2, T3, and T4 and thereby denote the light-emitting pattern, so as to find out the light-emitting device distinguished from the other light emitters merely as decoration pieces.

Further, because the light-emitting device is lighted up and blacked out during the cyclical periods T1, T2, T3, and T4 described hereinabove, it is possible to carry out a sampling with the same sampling period as the unit period T1 so as to find out those which do not change in color during each of the periods T1, T2, T3, and T4, thereby discovering the desired light-emitting device efficiently.

No. 6 Modifications

Hereinabove, the descriptions were made with respect to a technique for denoting a desired data by blinking the light emitters. However, a number of variations are conceivable in accordance with the present invention.

(1) Color

In the above examples, the explanations were made primarily on the code which denotes a data by means of the change or transition of color shown by the light emitters. However, the data may also be assigned to the color per se. For example, the data may also be expressed by such an assignment as:
R→0
G→1
B→2,
   and the like.

(2) Further, in the above examples, the explanations were made with the examples in which the data is denoted only by means of the change or transition of color shown by the light emitters and has no relation to the time interval of the change. However, the time interval may also be set to a predetermined period. Especially, in order to distinguish from the surroundings, it is preferable to adopt a combination of the predetermined time intervals as described hereinabove (for example, cyclical time intervals).

(2-a) Further, when the time interval of color change is predetermined as described in (2), it is also preferable to recognize each light emitter according to the predetermined time interval (referred to as a time pattern).

Further, when the abovementioned time pattern is predetermined, it is also preferable to assign the data to the colors as shown in (1).

(3) The Number of Colors

So far, the explanations have been primarily made with the examples of the three colors R, G, and B. However, it is also possible to utilize cyan, magenta, and yellow, of course, and other three colors as well.

Further, being not limited to three colors, it is also preferred to utilize two colors or more than three colors.

(4) Full-Color Light Emitter

In the examples described hereinabove, the explanations were made with the light emitters one of which emits a light of one color. However, it is also preferable to utilize light emitters one of which emits multicolor lights.

Such light emitters are known as those configured to be able to express full color by integrally forming two kinds of light sources or three-color light sources of R, G, and B, and the like. Many of them primarily utilize LEDs and are called by the names such as red-green two-color LED, full-color LED, multicolor LED, and the like.

Even if those light emitters are utilized which emit multicolor lights, they are, needless to say, “equivalent” to the invention set forth in the claims.

1. A light-emitting device comprising:
a light emitter 1 emitting a color light 1;
a light emitter 2 emitting a color light 2;
a light emitter 3 emitting a color light 3; and
a control means for lighting up and blacking out each of the light emitters 1 to 3 in a predetermined light-emitting pattern, the light-emitting device denoting a predetermined data by the predetermined light-emitting pattern.

2. A light-emitting device comprising:
n kinds of light emitters 1 to n emitting color lights 1 to n, respectively; and
a control means for lighting up and blacking out each of the n kinds of light emitters 1 to n in a predetermined light-emitting pattern,
the light-emitting device denoting a predetermined data by the predetermined light-emitting pattern; and
the n being an integer more than 1.

3. The light-emitting device according to claim 1, wherein the light-emitting pattern denotes the data by a sequence of change, transition, or light-up and black-out of the colors.

4. The light-emitting device according to claim 1, wherein the light-emitting pattern denotes the data by the colors.

5. The light-emitting device according to claim 1, wherein in the light-emitting pattern, at most only one of the colors switches between a light-up state and a black-out state at a time.

6. The light-emitting device according to claim 1, wherein in the light-emitting pattern, at least any one or more of the light emitters is/are constantly in a light-up state; and in no circumstances will all the light emitters be in a black-out state at the same time.

7. The light-emitting device according to claim 1, wherein the light-emitting pattern comprises a unit pattern for denoting the predetermined data; and a margin pattern for indicating a boundary of the unit pattern.

8. The light-emitting device according to claim 7, wherein in the margin pattern, at least any one or more of the light emitters is/are constantly in a light-up state; and in no circumstances will all the light emitters be in a black-out state at the same time.

9. The light-emitting device according to claim 8, wherein in the margin pattern, any of the light emitters is constantly in a light-up state.

10. The light-emitting device according to claim 9, wherein in the margin pattern, any of the light emitters other than those constantly in a light-up state repeatedly switches between light-up and black-out on a predetermined timing.

11. The light-emitting device according to claim 7, wherein the unit pattern comprises a start pattern for indicating a start of the unit pattern, and an end pattern for indicating an end of the unit pattern; the unit pattern starts from the start pattern and ends with the end pattern.

12. The light-emitting device according to claim 1, wherein in the light-emitting pattern, a timing of light-up or black-out of the light emitters is predetermined.

13. The light-emitting device according to claim 1, wherein the light emitter k is formed of a small light emitter or emitters emitting the color light k; the k is an integer from 1 to 3.

14. The light-emitting device according to claim 2, wherein the light emitter k is formed of a small light emitter or emitters emitting the color light k; the k is an integer from 1 to n.

15. The light-emitting device according to claim 1, wherein the light emitters are fixed or quasi-fixed in position each other.

16. A method for marking a mark object with an optical recognition code which utilizes the light-emitting device according to claim 1 and in which the colors change along the time axis, the method comprising:
a disposition step of disposing the light-emitting device on the mark object; and
a light emitting step of making the light-emitting device emit the lights in the predetermined light-emitting pattern;
the lights emitted by the light emitters forming the optical recognition code denoting the predetermined data.

17. The method for marking a mark object with an optical recognition code according to claim 16, wherein the light-emitting device comprises a storage means for storing the light-emitting pattern inputted from outside; and the control means changes a light-emitting state of the light emitters in accordance with the light-emitting pattern stored in the storage means so as to denote the optical recognition code.

18. A method for denoting an optical recognition code which utilizes the light-emitting device according to claim 1 and in which the colors change along the time axis, wherein the light-emitting device comprises a storage means for storing the light-emitting pattern inputted from outside; and the control means changes a light-emitting state of the light emitters in accordance with the light-emitting pattern stored in the storage means so as to denote the optical recognition code.

19. A data and position detection method for recognizing a position of a mark object by affixing to the mark object the light-emitting device according to claim 1 and utilizing an optical recognition code denoted by the light-emitting device, the method comprising the steps of:
photographing an image including the light-emitting device denoting the optical recognition code for denotation;
recognizing the optical recognition code from the photographed image so as to seek the position; and
reading out the recognized optical recognition code so as to restore the data denoted by the optical recognition code,
so as to acquire the position of the mark object marked with the optical recognition code and the data denoted by the optical recognition code.
